(19) United States
(12) Patent Application Publication
(10) Pub. No.: US 2021/0172603 A1
(43) Pub. Date: Jun. 10, 2021

(54) Microturbine and Combustor thereof

(71) Applicant: National Chung-Shan Institute of Science and Technology, Taoyuan City (TW)

(72) Inventors: Yung-Mao Tsuei, Nantou County (TW); Chih-Chuan Lee, Taichung City (TW); Sing-Mao Wu, Taichung City (TW)

(21) Appl. No.: 16/705,257

(22) Filed: Dec. 6, 2019

(51) Int. Cl. F23R 3/06; F23R 3/28

(52) U.S. Cl. CPC F23R 3/06; F02C 3/14; F23R 3/28

(57) ABSTRACT

A microturbine including a combustor, an igniter disposed adjacent to the combustor, and a plurality of fuel nozzles disposed adjacent to the combustor. The combustor includes a plurality of laser holes located merely in a region of the combustor.

### BACKGROUND OF THE INVENTION

### 1. Field of the Invention

The present invention relates to a microturbine and a combustor, and more particularly, to a microturbine and a combustor to be cooled efficiently with low cost.

### 2. Description of the Prior Art

Typically, fuel is injected into a combustor of a microturbine, and the air and fuel are mixed upon burning in a flame zone. To ensure even temperature distribution and low temperature on the exhaust orifice of the combustor, dilution holes are drilled at the front end of the combustor. Nevertheless, improper control of intake air volume and gas volume of the combustor may cause local high temperature areas, which discolors the combustor and shortens the service life of the combustor. Moreover, drilling may be expensive. Therefore, a more cost efficient cooling approach is needed.

### SUMMARY OF THE INVENTION

Therefore, the present application primarily provides a microturbine and a combustor to be cooled efficiently with low cost.

An embodiment of the present application discloses a microturbine including a combustor, an igniter disposed adjacent to the combustor, and a plurality of fuel nozzles disposed adjacent to the combustor. The combustor includes a plurality of laser holes located merely in a region of the combustor.

Another embodiment of the present application discloses a combustor including a plurality of laser holes located merely in a region of the combustor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram illustrating a top view of a microturbine according to an embodiment of the present invention.

FIG. 1B is a schematic diagram illustrating a side view of the microturbine shown in FIG. 1A.

FIG. 1C is a schematic diagram of the microturbine shown in FIG. 1A.

FIG. 2 is a schematic diagram illustrating simulation results of a combustor.

FIG. 3 is a schematic diagram illustrating experimental results of a combustor.

FIG. 4 is a schematic diagram illustrating a locally enlarged view of the microturbine shown in FIG. 1.

FIG. 5 is a cross-sectional view diagram along a cross-sectional line A-A′ of the microturbine shown in FIG. 4.

### DETAILED DESCRIPTION

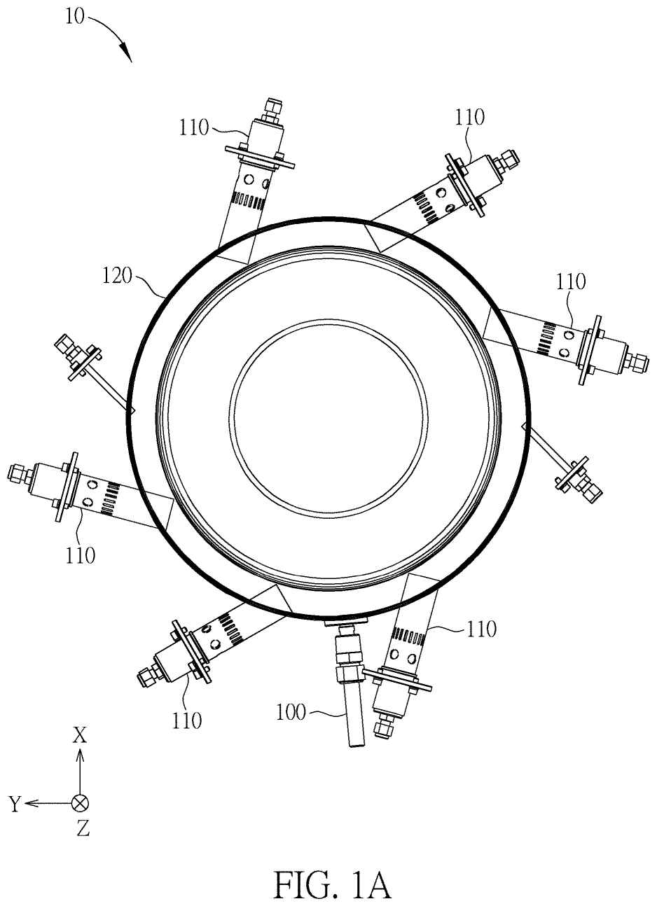

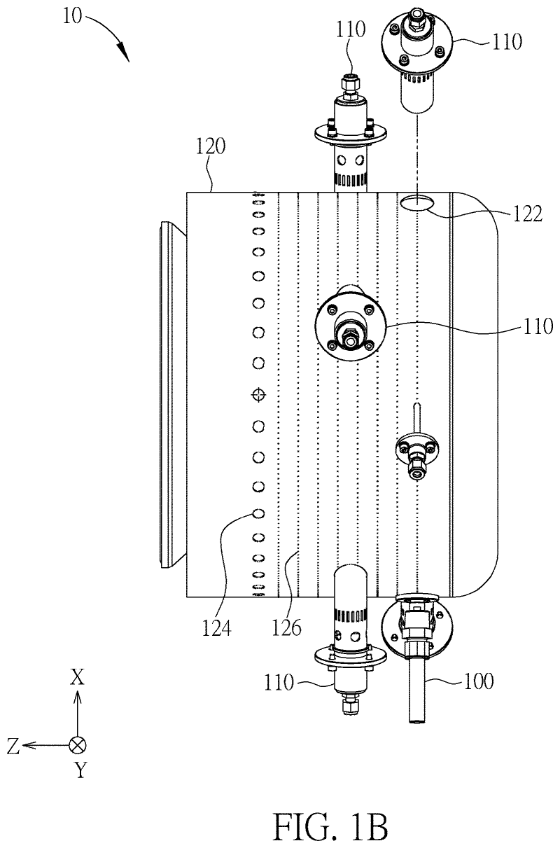

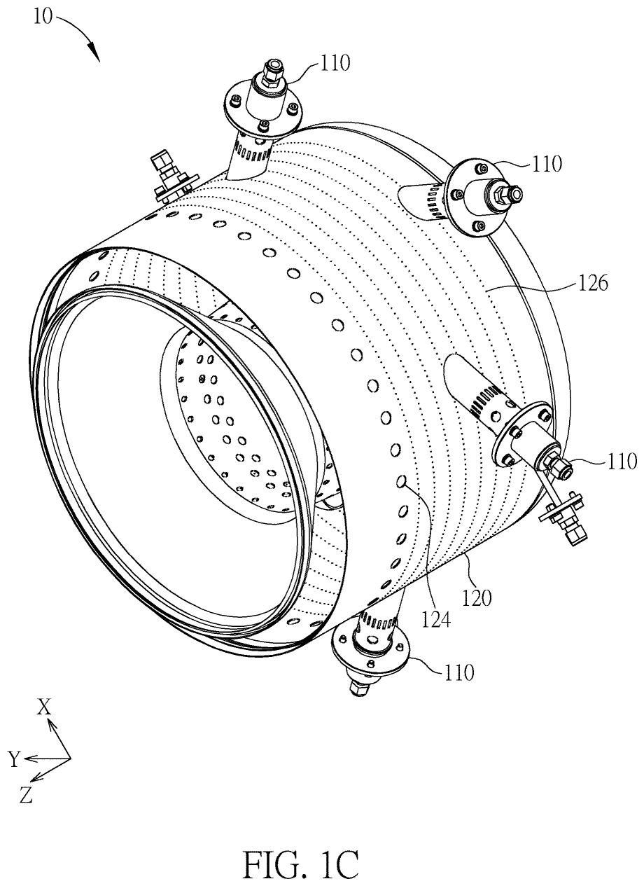

Please refer to FIG. 1A to FIG. 1D. FIG. 1A is a schematic diagram illustrating a top view of a microturbine 10 according to an embodiment of the present invention. FIG. 1B is a schematic diagram illustrating a side view of the microturbine 10 shown in FIG. 1A. FIG. 1C is a schematic diagram of the microturbine 10 shown in FIG. 1A. The microturbine 10 may be a turbine engine and is configured to burn various fuels such as methane, propane, biogas, wood gas and other biofuels. The microturbine 10 includes an igniter 100, a plurality of fuel nozzles 110 and a combustor 120. The igniter 100 is disposed adjacent to the combustor 120. The combustor 120 have a plurality of fuel nozzle orifices 122 to connect to the fuel nozzles 110 disposed adjacent to the combustor 120, a plurality of laser holes 126 for heat dissipation, and a plurality of dilution holes 124. Each of the fuel nozzles 110 is disposed corresponding to one fuel nozzle orifice 122.

Briefly, with the laser holes 126, a film of cooling air is developed along the surface of the combustor 120 and closely apposed on the surface of the combustor 120 so as to dissipate heat into the surrounding, thereby protecting the combustor 120 and extending the service life of the combustor 120. Moreover, the laser holes 126 are located in a high temperature region of the combustor 120 for cost reduction.

Specifically, when the microturbine 10 burns different fuel to generate electricity, high temperature discoloration area may be formed on the combustor 120 because fuel gas and (engine intake) air are mixed unevenly. Using the laser drilling technology to form the laser holes 126 on the combustor 120 (especially on the potential high temperature discoloration area of the combustor 120), high pressure cold air outside the combustor 120 may enter the combustor 120 through the laser holes 126 to create a film of cooling air along the inner wall of the combustor 120. The film of cooling air may isolate hot fuel gas in the combustor 120 to produce a film air cooling effect. This lowers temperature of the combustor 120 and protects the surface of the combustor 120 to increase its service life. Furthermore, the length of the combustor 120 may become shorter as heat dissipation efficiency is enhanced. Accordingly, in some embodiments, the laser holes 126 for heat dissipation are disposed on the surface of the combustor 120, such that a film of cooling air may be developed along the inner wall of the combustor 120 and closely apposed on the inner wall of the combustor 120.

In some embodiments, there may be numerous laser holes 126 drilled on all the surface of the combustor 120. However, the more the laser holes 126, the higher the manufacturing cost. In addition, the difficulty of laser drilling technology for the combustor 120 may increase. Accordingly, in some embodiments, because forming the laser holes 126 may incur considerable expense, the laser holes 126 are limited in a region to reduce cost. In some embodiments, the laser holes 126 are locally distributed. In some embodiments, the laser holes 126 are located merely in a high temperature region (especially a potential thermal deformation area or the potential high temperature discoloration area) of the combustor 120 for cost reduction as well as heat dissipation. That is to say, a temperature of the (high temperature) region is higher than a front end or a back end of the combustor 120. In some embodiments, it is not necessary to form the laser holes 126 in non-discoloration area. Obviously, without drilling the laser holes 126 on all the surface of the combustor 120, the microturbine 10 ensures low manufacturing cost. Locally distribution of the laser holes 126 may be applied to various microturbine combustors and turbine engine combustors.

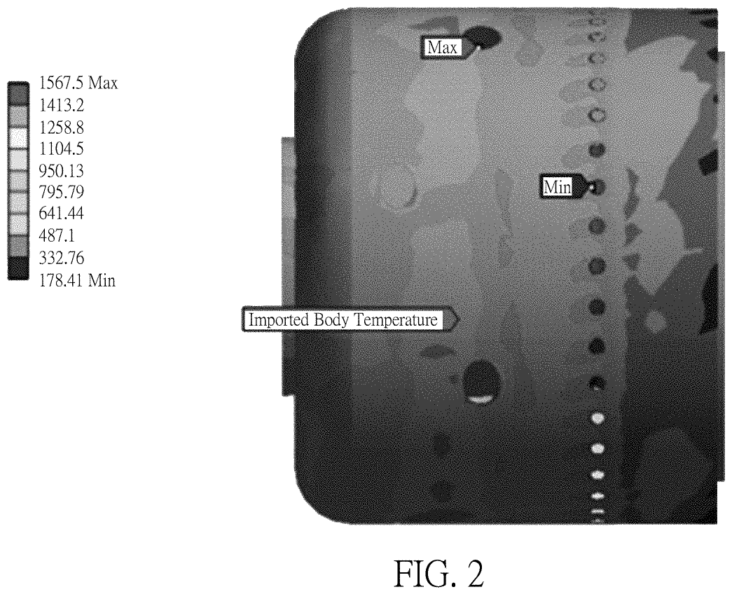

In some embodiments, the laser holes 126 may be disposed adjacent to the fuel nozzle orifices 122. In some embodiments, the fuel nozzle orifices 122 may be distributed in an array formed by the laser holes 126. Please refer to FIG. 2. FIG. 2 is a schematic diagram illustrating simulation results of a combustor. According to flow field analysis, the maximum temperature of high temperature gas in the combustor may be 2150° C., and the temperature of high pressure air outside the combustor may be 170° C. The temperature difference between the inside and the outside of the combustor is large. The temperature distribution, thermal stress and thermal deformation of the combustor may be further calculated by fluid solid coupling. Additionally, the flow rate of cold air outside the combustor is almost double the flow rate of hot air inside the combustor. As shown in FIG. 2, temperature near the fuel nozzle orifices is below 1412° C. In other words, a high temperature region of temperature about 1250° C., which exceeds the melting point of a combustor, is located near the fuel nozzle orifices 122. An area near the fuel nozzle orifices or between any two fuel nozzle orifices may be a potential thermal deformation area or a potential high temperature discoloration area of a combustor. Therefore, in some embodiments, the laser holes 126 may be disposed in the potential thermal deformation area or the potential high temperature discoloration area and thus adjacent to the fuel nozzle orifices 122. In this manner, a film of cooling air may developed near the potential thermal deformation area or the potential high temperature discoloration area, such that the temperature may be lowered by 200° C. in the potential thermal deformation area or the potential high temperature discoloration area.

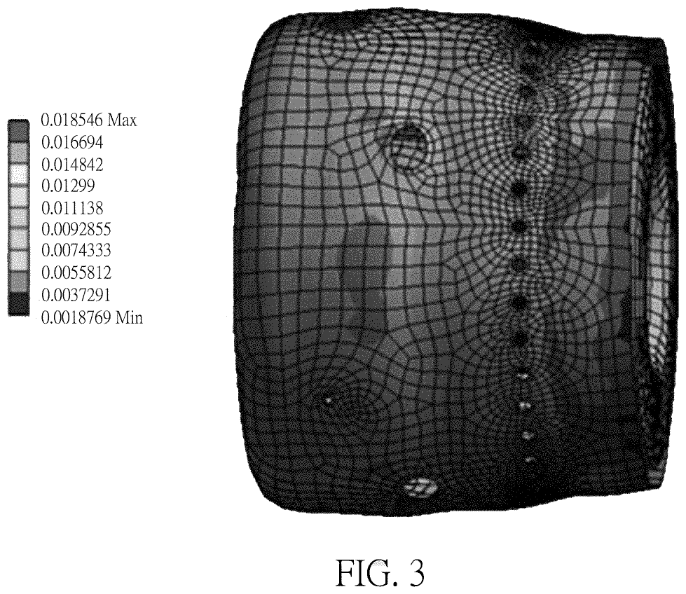

Similarly, please refer to FIG. 3. FIG. 3 is a schematic diagram illustrating experimental results of a combustor. According to FIG. 3, there is discoloration and deformation near the fuel nozzle orifices after low temperature combustion of a combustor. It is indicated that temperature of a combustor is high near the fuel nozzle orifices. An area near the fuel nozzle orifices 122 or between any two fuel nozzle orifices 122 may be a potential thermal deformation area or a potential high temperature discoloration area of a combustor. Therefore, in some embodiments, the laser holes 126 may be disposed in potential thermal deformation area or the potential high temperature discoloration area and thus adjacent to the fuel nozzle orifices 122.

Furthermore, as shown in FIG. 1, the laser holes 126 are arranged in an array. In other words, the laser holes 126 may be divided into different laser hole groups. The laser holes 126 in each laser hole group are aligned in one circle and surround the combustor 120. In some embodiments, there are eight laser hole groups. In some embodiments, (centers of) the laser holes 126 are aligned in eight circles respectively. In some embodiments, for heat dissipation, there are five laser hole groups disposed between the fuel nozzle orifices 122 and the back end of the combustor 120. The laser holes 126 of the five laser hole groups are aligned in five circles respectively. In some embodiments, for heat dissipation, there are three laser hole groups disposed between the fuel nozzle orifices 122 and the dilution holes 124. The laser holes 126 of the three laser hole groups are aligned in three circles respectively. In some embodiments, there is no need to add laser holes 126 in other area of the combustor 120, thereby greatly reducing the manufacturing cost. In some embodiments, the number or the density of the laser holes 126 is related to the (surface) temperature of the combustor 120. In some embodiments, the number or the density of the laser holes 126 is increased as the temperature of the surface of the combustor 120 increases.

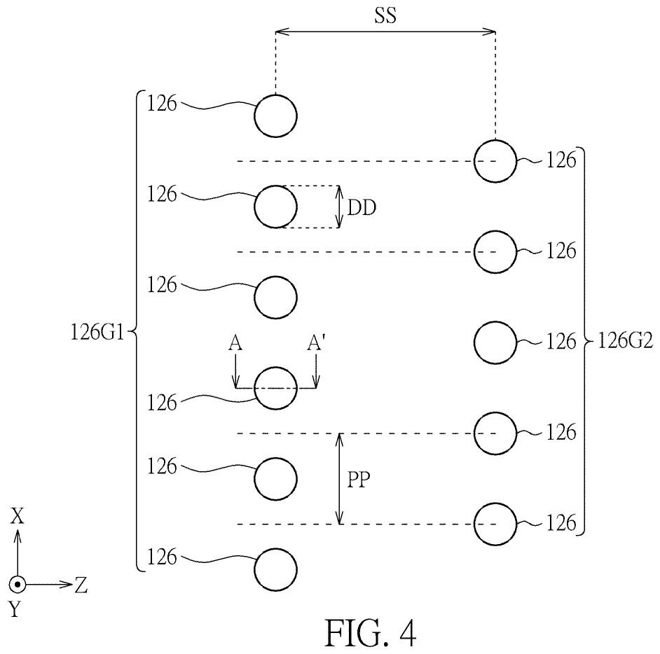

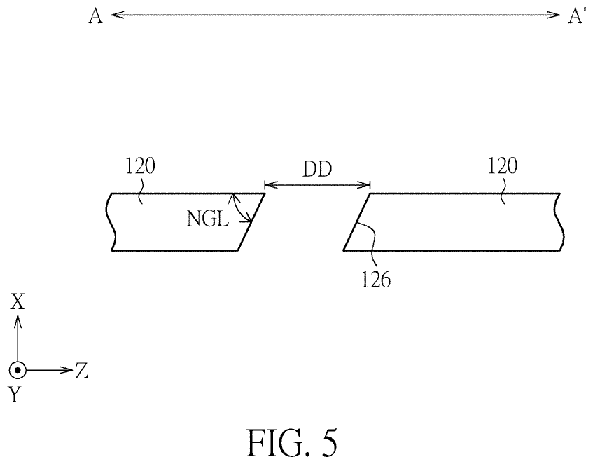

In addition, please refer to FIG. 4 and FIG. 5. FIG. 4 is a schematic diagram illustrating a locally enlarged view of the microturbine 10 shown in FIG. 1. FIG. 5 is a cross-sectional view diagram along a cross-sectional line A-A′ of the microturbine 10 shown in FIG. 4. In some embodiments, a diameter DD of the laser hole 126 shown in FIG. 4 may be substantially 0.015 inches to 0.03 inches, but not limited thereto. In some embodiments, an angle NGL of the laser hole 126 shown in FIG. 5 may be substantially in a range of 45 degrees to 90 degrees, but not limited thereto. In some embodiments, the angle NGL of the laser hole 126 may be substantially 60 degrees accordingly to heat dissipation efficiency, hot cold flow rate ratio, and a group spacing ratio of a spacing SS to the diameter DD. The heat dissipation efficiency is calculated according to FF=(Thot-Twall)/(Thot-Tcold), where FF is the heat dissipation efficiency, Thot is the temperature of hot air, Twall is the temperature of the wall of the combustor 120, and Tcold is the temperature of cold air. The hot cold flow rate ratio is calculated according to RR=(Dcold*Vcold)/(Dhot*Vhot), where RR is the hot cold flow rate ratio, Dcold and Vcold are the density and the air velocity of cold air, Dhot and Vhot are the density and the air velocity of hot air. In some embodiments, the hot cold flow rate ratio may be substantially 2, but not limited thereto.

In some embodiments, the group spacing ratio of the spacing SS to the diameter DD may be substantially in a range of 20:1 to 40:1, but not limited thereto. In some embodiments, the laser hole groups may include a first laser hole group 126G1 and a second laser hole group 126G2, and (the laser holes 126 in) the first laser hole group 126G1 are adjacent to (the laser holes 126 in) the second laser hole group 126G2. In some embodiments, the laser holes 126 (also referred to as first laser holes) in the first laser hole group 126G1 and the laser holes 126 (also referred to as second laser holes) in the second laser hole group 126G2 are spaced apart by the spacing SS. In some embodiments, any two adjacent laser hole groups (for instance, the first laser hole group 126G1 and the second laser hole group 126G2) are spaced apart by the spacing SS shown in FIG. 4. In some embodiments, the group spacing ratio of the spacing SS to the diameter DD may be substantially 30:1. In some embodiments, when the angle NGL is 60 degrees, the hot cold flow rate ratio is 2, and the group spacing ratio is 30:1, the temperature of the wall of the combustor 120 may be lowered by 1000° C.

In some embodiments, the pitch ratio of a pitch PP to the diameter DD may be substantially in a range of 4:1 to 12:1, but not limited thereto. (The centers of) two laser holes 126 adjacent to each other in a laser hole group are spaced apart by the pitch PP shown in FIG. 4. In some embodiments, the temperature of the wall of the combustor 120 is evener when the pitch ratio is smaller. However, smaller pitch ratio means more laser holes 126 disposed on the combustor 120, which increases the manufacturing cost. To decrease the pitch ratio without adding more laser holes 126, a misaligned hole design is adopted, and the pitch PP may increase to make the pitch ratio of the pitch PP to the diameter DD equal to 8:1. As shown in FIG. 4, the laser holes 126 are alternately arranged or distributed to realize the misaligned hole design. That is to say, the laser holes 126 (also referred to as first laser holes) in the first laser hole group 126G1 are misaligned to the laser holes 126 (also referred to as second laser holes) in the second laser hole group 126G2. In some embodiments, the laser holes 126 in one laser hole groups (for instance, the first laser hole group 126G1) are misaligned to the laser holes 126 in another adjacent laser hole group (for instance, the second laser hole group 126G2). A center of each laser hole 126 in the first laser hole group 126G1 is aligned to none of the centers of the laser holes 126 in the second laser hole group 126G2.

In some embodiments, the laser holes 126 may be formed on the combustor 120 by the laser drilling technology. Specifically, the combustor 120 is operated under high temperature and faces high temperature flow field first. Besides, the combustor 120 may have a large volume. Furthermore, the combustor 120 should be used for and applicable to different fuels. However, flow or heating value of different fuels, especially fuels such as biofuels and domestic garbage, varies with the composition of the fuels. And multi fuel combustion may impact the temperature of the wall of the combustor 120 dramatically. The temperature control of the combustor 120 is thus difficult (or difficult to be accurate), and the unevenness of temperature may reduce the service life of the combustor 120 significantly. In such a situation, the laser holes 126 are drilled with the laser drilling technology. In the laser drilling technology, small spots are generated by the laser on the high temperature region of the combustor 120. A light beam is moved in a circular range to form the laser holes 126. The laser holes 126 may be formed at low speed but the shape of the laser holes 126 is perfect. After drilling, high pressure cold air outside the combustor 120 may enter the combustor 120 through the laser holes 126 to create a film of cooling air along the inner wall of the combustor 120, thereby achieving the film air cooling effect. This lowers temperature of the combustor 120 and thus extends its service life.

In summary, with the laser holes 126 formed on the combustor 120 of the present invention, a film of cooling air is developed along the surface of the combustor 120 and closely apposed on the surface of the combustor 120 so as to dissipate heat into the surrounding, thereby protecting the combustor 120 and extending the service life of the combustor 120. Moreover, the laser holes 126 are located in a high temperature region of the combustor 120 for cost reduction.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A microturbine, comprising:
a combustor, comprising a plurality of laser holes located merely in a region of the combustor;
an igniter, disposed adjacent to the combustor; and
a plurality of fuel nozzles, disposed adjacent to the combustor.

2. The microturbine of claim 1, wherein a temperature of the region is higher than a front end or a back end of the combustor.

3. The microturbine of claim 1, wherein the plurality of laser holes are disposed adjacent to the plurality of fuel nozzles.

4. The microturbine of claim 1, wherein the plurality of laser holes are arranged in an array, the plurality of fuel nozzles are distributed in the array.

5. The microturbine of claim 1, wherein the plurality of laser holes are alternately arranged.

6. The microturbine of claim 1, wherein a number or a density of the plurality of laser holes is related to a temperature of the combustor.

7. The microturbine of claim 1, wherein a diameter of each of the plurality of laser holes is 0.015 inches to 0.03 inches.

8. The microturbine of claim 1, wherein an angle of each of the plurality of laser holes is in a range of 45 degrees to 90 degrees.

9. The microturbine of claim 1, wherein a group spacing ratio of a spacing to a diameter of each of the plurality of laser holes is in a range of 20:1 to 40:1, wherein the plurality of laser holes comprises a plurality of first laser holes and a plurality of second laser holes, wherein the plurality of first laser holes and the plurality of second laser holes are spaced apart by the spacing.

10. The microturbine of claim 1, wherein a pitch ratio of a pitch to a diameter of each of the plurality of laser holes is in a range of 4:1 to 12:1, wherein two of the plurality of laser holes adjacent to each other are spaced apart by the pitch.

11. A combustor, comprising:
a plurality of laser holes, located merely in a region of the combustor.

12. The combustor of claim 11, wherein a temperature of the region is higher than a front end or a back end of the combustor.

13. The combustor of claim 11, wherein the plurality of laser holes are disposed adjacent to the plurality of fuel nozzles.

14. The combustor of claim 11, wherein the plurality of laser holes are arranged in an array, the plurality of fuel nozzles are distributed in the array.

15. The combustor of claim 11, wherein the plurality of laser holes are alternately arranged.

16. The combustor of claim 11, wherein a number or a density of the plurality of laser holes is related to a temperature of the combustor.

17. The combustor of claim 11, wherein a diameter of each of the plurality of laser holes is 0.015 inches to 0.03 inches.

18. The combustor of claim 11, wherein an angle of each of the plurality of laser holes is in a range of 45 degrees to 90 degrees.

19. The combustor of claim 11, wherein a group spacing ratio of a spacing to a diameter of each of the plurality of laser holes is in a range of 20:1 to 40:1, wherein the plurality of laser holes comprises a plurality of first laser holes and a plurality of second laser holes, wherein the plurality of first laser holes and the plurality of second laser holes are spaced apart by the spacing.

20. The combustor of claim 11, wherein a pitch ratio of a pitch to a diameter of each of the plurality of laser holes is in a range of 4:1 to 12:1, wherein two of the plurality of laser holes adjacent to each other are spaced apart by the pitch.
